(19) United States
(12) Patent Application Publication
(10) Pub. No.: US 2008/0245647 A1
(43) Pub. Date: Oct. 9, 2008

(54) Two-Stage Power Button

(76) Inventors: Adam B. Childers, Tucson, AZ (US); Joni E. Saylor, Tucson, AZ (US)

Correspondence Address: DILLON & YUDELL, LLP, 8911 N CAPITAL OF TEXAS HWY, SUITE 2110, AUSTIN, TX, 78759, US

(21) Appl. No.: 11/696,367

(22) Filed: Apr. 4, 2007

(51) Int. Cl. H01H 3/20

(52) U.S. Cl. 200/539

(57) ABSTRACT

A manually actuated two-stage power button for a computer system is disclosed. The power button includes a living hinge, first and second legs and a spring mechanism. The first and second legs are integrally connected to the living hinge. Portions of the first and second legs are located on one side of a bezel of the computer system. The first and second legs are parallel to each other in an unactuated state, and the first and second legs need to be pinched simultaneously towards each other and are then pushed inward into the bezel in order to actuate the power button. The spring mechanism along with the living hinge can return the first and second legs to the unactuated state after the power button has been actuated.

### BACKGROUND OF THE INVENTION

1. Technical Field

The present invention relates to electromechanical devices in general, and more particularly, to power buttons. Still more particularly, the present invention relates to a manually actuated two-stage power button.

2. Description of Related Art

Power buttons are typically utilized to selectively enable or inhibit the flow of electrical current to electronic devices. In conventional computer systems, manually actuated push buttons are commonly utilized as power buttons.

With a manually push-actuated power button located on the front panel of a computer system, any accidental contact with the power button may cause an inadvertent shutdown of the computer system. Prior art solutions, such as adding snap-in safety “donuts” around power buttons or placing doors to cover power buttons, can prevent accidental actuation of push-actuated power buttons. However, these protective measures also limit visibility and increase the complexity of system assemblies.

Consequently, it would be desirable to provide an improved manually actuated power button for a computer system.

### SUMMARY OF THE INVENTION

In accordance with a preferred embodiment of the present invention, a manually actuated power button for a computer system includes a living hinge, first and second legs and a spring mechanism. The first and second legs are integrally connected to the living hinge. Portions of the first and second legs are located on one side of a bezel of the computer system. The first and second legs are parallel to each other in an unactuated state, and the first and second legs need to be pinched simultaneously towards each other and are then pushed inward into the bezel in order to actuate the power button. The spring mechanism along with the living hinge can return the first and second legs to the unactuated state after the power button has been actuated.

All features and advantages of the present invention will become apparent in the following detailed written description.

### BRIEF DESCRIPTION OF THE DRAWINGS

The invention itself, as well as a preferred mode of use, further objects, and advantages thereof, will best be understood by reference to the following detailed description of an illustrative embodiment when read in conjunction with the accompanying drawings, wherein:

FIG. 1 is a side view of a two-stage power button in an unactuated state, in accordance with a preferred embodiment of the present invention;

FIG. 2 is a side view of the two-stage power button from FIG. 1 in an actuated state, in accordance with a preferred embodiment of the present invention; and

FIG. 3 is a side view of a two-stage power button in an actuated state, in accordance with an alternative embodiment of the present invention.

### DETAILED DESCRIPTION OF A PREFERRED EMBODIMENT

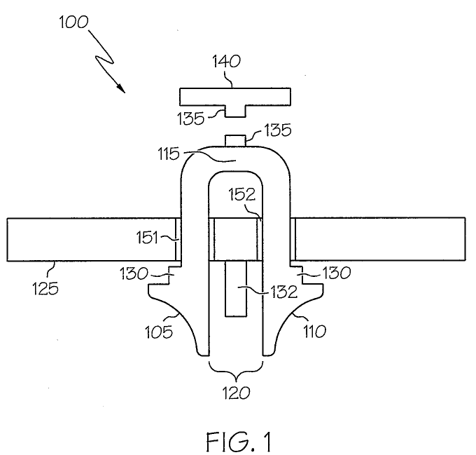

With reference now to the figures, and in particular to FIG. 1, there is illustrated a side view of a two-stage power button, in accordance with a preferred embodiment of the present invention. As shown, a two-stage power button 100 includes a first leg 105 and a second leg 110 integrally connected to a U-shape living hinge 115. First leg 105 and second leg 110 include push stops 130, which are initially positioned on the front side of a surface bezel 125 of, for example, a computer system. Push stops 130 prevent first leg 105 and second leg 110 from retreating through openings 151 and 152 of surface bezel 125 during any accidental contact with first leg 105 and/or second leg 110.

In an unactuated (default) position, first leg 105 and second leg 110 are parallel to each other separated by a gap 120. First leg 105 and second leg 110 can be pinched or squeezed towards each other via mechanical force, but they will return to their unactuated position by living hinge 115 after the mechanical force has been removed from first leg 105 and second leg 110.

Power button 100 can be actuated by two separate and distinct motions from an operator. Initially, the operator pinches (or squeezes) both first leg 105 and second leg 110 towards each other, then the operator can push both first leg 105 and second leg 110 inward. The pinches should be far enough to allow push stops 130 to align with openings 151 and 152 such that first leg 105 and second leg 110 can be pushed inward to allow electrical contacts 135 to make contact with each other. Once electrical contacts 135 have made contact with each other, the state of a switch circuit 140 can be changed. For example, the state of switch circuit 140 can be changed from an inactive state (i.e., power off) to an active state (i.e., power on) after a first contact, and the state of switch circuit 140 can then be reverted back to the inactive state after a second contact.

Living hinge 115 can be connected to a spring mechanism (not shown) to allow living hinge 115 as well as first leg 105 and second leg 110 to return to their unactuated position after the pinching and pushing actions.

A pinch stop 132, which is located on surface bezel 125, is utilized to prevent first leg 105 and second leg 110 from moving further than a maximum required distance during the pinching action. Pinch stop 125 also prevents power button 100 from being actuated when only one of either first leg 105 or second leg 110 is pressed fully inward.

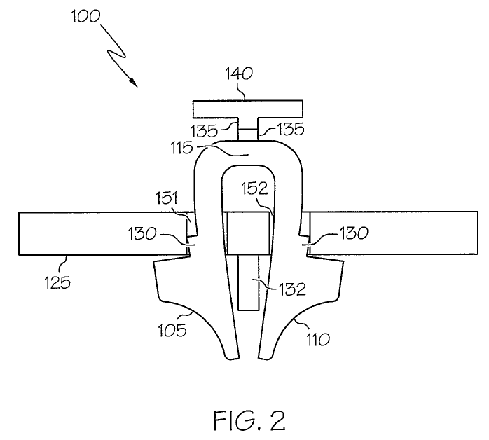

With reference now to FIG. 2, there is illustrated a side view of power button 100 in an actuated state, in accordance with a preferred embodiment of the present invention. As shown, push stops 130 are aligned with openings 151 and 152 such that first leg 105 and second leg 110 are pushed inward such that electrical contacts 135 make contact with each other.

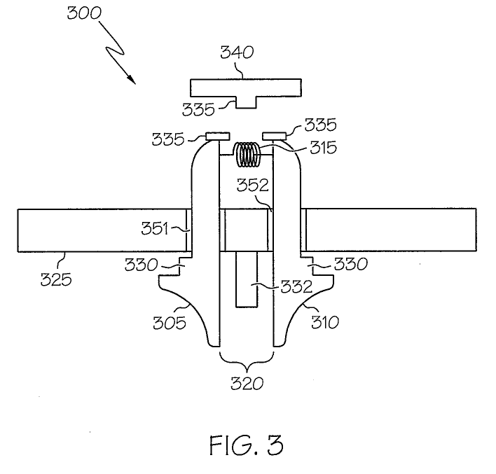

With reference now to FIG. 3, there is illustrated a side view of a power button, in accordance with an alternate embodiment of the present invention. As shown, a power button 300 includes a first leg 305 and a second leg 310 connected to a spring mechanism 315. First leg 305 and second leg 310 include push stops 330, which are initially positioned on the front side of a surface bezel 325. Push stops 330 prevent first leg 305 and second leg 310 from retreating through openings 351 and 352 of surface bezel 325 during any accidental contact with first leg 305 and/or second leg 310.

In an unactuated (default) position, first leg 305 and second leg 310 are parallel to each other separated by gap 320. First leg 305 and second leg 310 can be pinched or squeezed towards each other via mechanical force, but they will be returned to their unactuated position by spring mechanism 315 after the mechanical force has been removed from first leg 305 and second leg 310.

Power button 300 can be actuated by two separate and distinct motions from an operator. Initially, the operator pinches (or squeezes) both first leg 305 and second leg 310 towards each other, then the operator can push both first leg 305 and second leg 310 inward. The pinches should be far enough to allow push stops 330 to align with openings 351 and 352 such that first leg 305 and second leg 310 can be pushed inward to allow electrical contacts 335 to make contact with each other. Once electrical contacts 335 have made contact with each other, the state of a switch circuit 340 can be changed. For example, the state of switch circuit 340 can be changed from an inactive state (i.e., power off) to an active state (i.e., power on) after a first contact, and the state of switch circuit 340 can then be reverted back to the inactive state after a second contact.

A pinch stop 332, which is located on surface bezel 325, is utilized to prevent first leg 305 and second leg 310 from moving further than a maximum required distance during the pinching action. Pinch stop 325 also prevents power button 300 from being actuated when only one side of either first leg 305 and second leg 310 is pressed fully inward.

As has been described, the present invention provides a manually actuated two-stage power button. The power button of the present invention enables a manually actuated power button to remain uncovered, clearly visible, and easily accessible without the use of a tool, while reducing the likelihood of inadvertent actuation.

While the invention has been particularly shown and described with reference to a preferred embodiment, it will be understood by those skilled in the art that various changes in form and detail may be made therein without departing from the spirit and scope of the invention.

What is claimed is:

1. A power button located on a bezel, said power button comprising:
a living hinge;
first and second legs integrally connected to said living hinge, wherein portions of said first and second legs are located on one side of said bezel, wherein said first and second legs are parallel to each other in an unactuated state, wherein said first and second legs needs to be pinched simultaneously towards each other and are then pushed inward into said bezel in order to actuate said power button; and
a spring mechanism for returning said first and second legs to said unactuated state after said power button has been actuated.

2. The power button of claim 1, wherein said first and second legs include push stops.

3. The power button of claim 1, wherein said bezel further includes a pinch stop for preventing said first and second legs from moving further than a maximum required distance during a pinching action.

4. A power button located on a bezel, said power button comprising:
a spring mechanism; and
first and second legs connected to said spring mechanism, wherein portions of said first and second legs are located on one side of said bezel, wherein said first and second legs are parallel to each other in an unactuated state, wherein said first and second legs need to be pinched simultaneously towards each other in order to actuate said power button, wherein said spring mechanism returns said first and second legs to said unactuated state after said power button has been actuated.

5. The power button of claim 4, wherein said first and second legs include push stops.

6. The power button of claim 4, wherein said bezel further includes a pinch stop for preventing said first and second legs from moving further than a maximum required distance during a pinching action.
